(19) United States
(12) Patent Application Publication
(10) Pub. No.: US 2009/0213843 A1
(43) Pub. Date: Aug. 27, 2009

(54) METHOD AND APPARATUS FOR ENABLING VOICE COMMUNICATION

(76) Inventors: Sandip Chattopadhya, Rancho Cucamonga, CA (US); Magdalena Kruk-Chattopadhya, Rancho Cucamonga, CA (US); Harminder Sandhu, Burnaby (CA); Elbert Shiang, Palo Alto, CA (US); Atiq Raza, Palo Alto, CA (US)

Correspondence Address: Stevens Law Group, 1754 Technology Drive, Suite #226, San Jose, CA, 95110, US

(21) Appl. No.: 12/390,294

(22) Filed: Feb. 20, 2009

Related U.S. Application Data
(60) Provisional application No. 61/030,856, filed on Feb. 22, 2008.

(51) Int. Cl. H04L 12/66; H04M 7/00

(52) U.S. Cl. 370/352; 379/220.01

(57) ABSTRACT

An embodiment of the invention is directed to a method, wherein it is received, at an origin device, input from a first telephonic device via an origin telephonic landline. An initiation request is then output based on the input to a destination device, wherein the destination device is configured to output a call request to a second telephonic device via a destination telephonic landline. Another embodiment of the invention is directed to a method, including receiving, at a server, a request from an origin device, wherein the origin device is configured to receive input from a first telephonic device via an origin telephonic landline. Information is then output, based on the input, regarding a destination device to the origin device, wherein the destination device is configured to output a call request to a second telephonic device via a destination telephonic landline.

### RELATED APPLICATIONS

This application claims priority based on U.S. Provisional Application No. 61/030,856, filed on Feb. 22, 2008, entitled “A method of creating an international network of mobile handheld devices operating on disparate networks using home Personal Computers connected on the internet and phone lines.”

### BACKGROUND OF THE INVENTION

Mobile handheld devices operate on local and national cellular networks belonging to telecommunication carriers. Communication between the mobile devices is performed using radio frequency signals which are transmitted and received from and to cell towers. If the mobile devices are located in the same carrier network then the transmission costs and the charge to the user are inexpensive. Also, charges to a mobile user operating between two or more national networks are relatively cheap. However, communications between cell or mobile phones located in different countries and continents often result in very high costs and charges to the user.

This causes difficulty in maintaining voice communications internationally amongst friends and family. In addition, international business travelers find it very expensive and troublesome to make telephone calls to the business region of their country of origin. They can use their hotel phones and pay exorbitant prices. One can also rent a mobile phone and pay very expensive international calling rates.

A company called Skype offers a service where people can talk internationally from their home personal computers. These PCs are connected on the internet and the user uses the PC's speakers and microphone to conduct a conversation. No mobile phones can be used and the users are tied down to the PC in order to conduct the conversation. This may be frustrating in many circumstances, especially for a traveler who would like to take a call from a friend in a different country and time zone while he is out and away from a computer.

Another service called Skype Out enables users to call international users from their PCs to another user's cell phone. So a user sitting at their PC can call another user on his or her cell phone. In order to achieve this, Skype has created an infrastructure of VOIP equipments worldwide. The call from the PC is routed as digitized voice data over the internet to one of Skype's servers in the country. The server then makes a PSTN call to the phone. This service is thus not free of charge. Also, the PC user will have to use the speakers and microphone of the PC and is tied down to the PC, as this service does not offer cell phone flexibility on both sides of the call. In addition, this service does not provide a method for a caller from a phone to call the PC, or in other words, the reverse call cannot be accomplished. Hence, it is desirable to have a solution, without the above-described disadvantages, such as a low-cost service by which voice communication via a telephonic device may be enabled. As will be seen, the invention provides such a solution in an elegant manner.

### BRIEF DESCRIPTION OF THE DRAWINGS

FIG. 1 illustrates an embodiment of the invention.

FIG. 2 illustrates an embodiment of the invention.

FIG. 3 illustrates a flowchart of an embodiment of the invention.

FIG. 4 illustrates a flowchart of an embodiment of the invention.

FIG. 5 illustrates a flowchart of an embodiment of the invention.

FIG. 6 illustrates a flowchart of an embodiment of the invention.

FIG. 7 illustrates a flowchart of an embodiment of the invention.

FIGS. 8A-B illustrates a flowchart of an embodiment of the invention.

FIG. 9 illustrates an embodiment of the invention.

FIG. 10 illustrates an embodiment of the invention.

FIG. 11 illustrates an embodiment of the invention.

FIG. 12 illustrates an embodiment of the invention.

FIG. 13 illustrates an embodiment of the invention.

FIG. 14 illustrates an embodiment of the invention.

FIG. 15 illustrates an embodiment of the invention.

FIG. 16 illustrates an embodiment of the invention.

FIG. 17 illustrates an embodiment of the invention.

FIG. 18 illustrates an embodiment of the invention.

FIG. 19 illustrates an embodiment of the invention.

FIG. 20 illustrates an embodiment of the invention.

### DETAILED DESCRIPTION OF THE INVENTION

An embodiment of the invention is directed to a method which creates a network for communication between cell phone devices using the user's home personal computer. The home personal computer is connected to the internet using a broadband connection like DSL or cable modem. The home personal computer is also connected to the regular landline telephone network using a dialup modem. For example, the user may make a regular phone call from a cell phone or any phone to the home phone. Then the user may enter the international phone number using the phone keypad. The international phone rings and if the phone is answered, the call is completed.

In particular, an embodiment of the invention is directed to a method, wherein it is received, at an origin device, input from a first telephonic device via an origin telephonic landline. An initiation request is then output based on the input to a destination device, wherein the destination device is configured to output a call request to a second telephonic device via a destination telephonic landline.

Another embodiment of the invention is directed to a method, including receiving, at a destination device, an initiation request from an origin device based on input, wherein the input is from a first telephonic device via an origin telephonic landline to the origin device. A call request is then output to a second telephonic device via a destination telephonic landline.

Another embodiment of the invention is directed to a method, including receiving, at a server, a request from an origin device, wherein the origin device is configured to receive input from a first telephonic device via an origin telephonic landline. Information is then output, based on the input, regarding a destination device to the origin device, wherein the destination device is configured to output a call request to a second telephonic device via a destination telephonic landline.

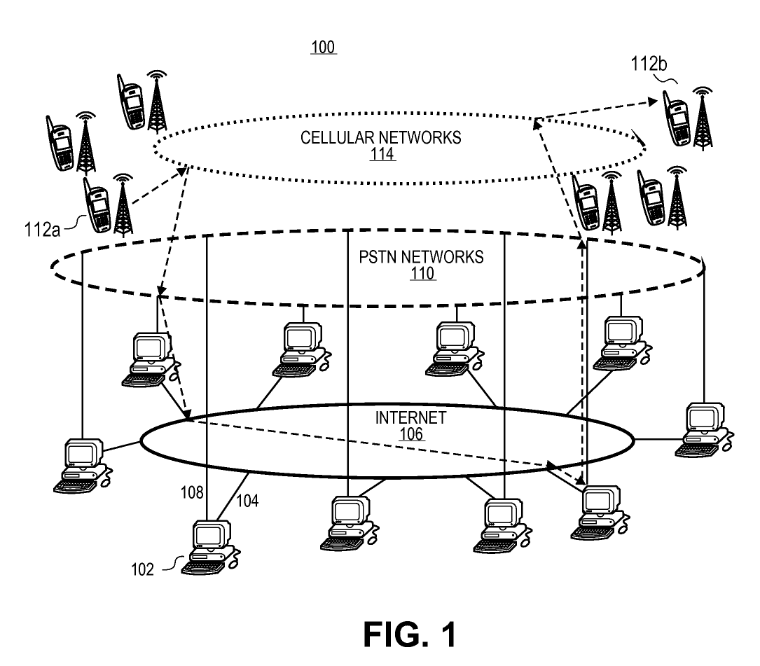

FIG. 1 shows an embodiment of an international network 100 of mobile cell phones. Home personal computers (PC) 102 may be interconnected by broadband connections 104 over the internet 106. The PCs 102 are also connected via their modem connections 108 to the telephone network(s) 110 of the country's local telecom carrier. The mobile phones 112 are connected to the cellular network(s) 114 of their individual carriers. The dotted arrow shows the direction in which a call may start from one mobile phone device 112a, proceed and traverse through the different networks, and finally reach the mobile phone 112b at the other end.

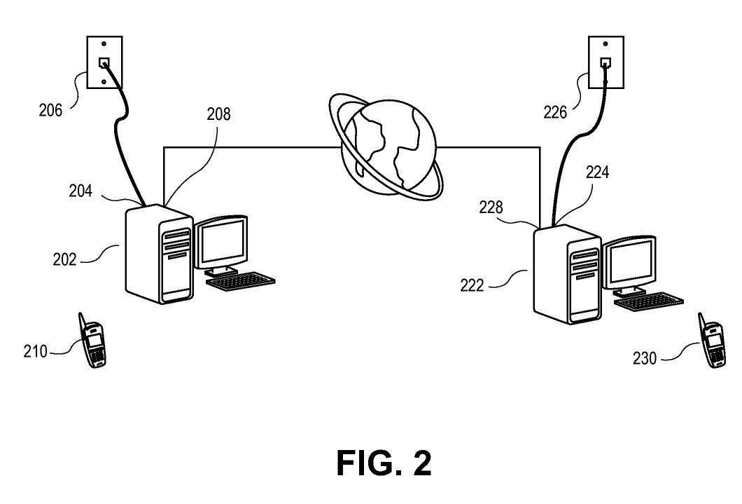

An embodiment of the invention is illustrated in FIG. 2, where a PC 202 at, for example, the user's home and another PC 222 at, for example, the international destination city may be involved in the call processing. Both PCs 202/222 may have their dial up modem ports 204/224 connected to a land phone line 206/226. The PCs 202/222 may also each have a broadband connection 208/228 to the internet. When a call is placed, from a cell phone 210 or another phone, to the home phone number, special software running on the home PC 202 picks up the call. The user then dials the international number which is collected by the software. The home PC 202 then makes a VOIP call (IP call) to the international destination PC 222. If the international PC 222 picks up the call, then the international phone number may be transmitted. The international PC 222 then initiates an outgoing call to the local number. If the called party picks up with cell phone 230 or another phone, the call is completed. Voice data received by the two PCs 202/222 is sent over the internet to each other and then to the respective phone lines 206/226. The cost of the international call is then reduced to the national or local call cost, if any. The reverse call, such as from the phone 230 to phone 210, may also be conducted in a similar manner.

In this way, users may freely converse on their mobile phones from anywhere, at relatively low cost, without being tied down to a PC. By contrast, Skype does not offer the advantage of being able to connect the PC to the telephone network. The invention offers a method of connecting a PC based Voice Over IP (VOIP) network to a regular telephone network using a home PC. The PC's modem and developed software modules enable this transfer of voice data between the analog telephone network and the IP based internet. Again, the local carriers' connection between the wired and wireless networks is used to communicate with the mobile phones over the cellular network. Skype offers no such linkages between disparate networks, as the invention does, by using home PC standard hardware and developed software.

In an embodiment of the invention, the key to the functioning of the telephone calling process is the software running on the PCs. This software is the client portion which executes on, for example, the PCs 202/222. The software may be downloaded by a user from a company's website. The process of downloading may also involve user registration with the company's server. Software running on the company's server may be responsible for maintaining a user directory and presence information of the respective users. Presence information may indicate, for example, whether a user's PC is online and/or if the client's software is executing on the user's PC. Presence information may be updated in real time and communicated to the user PCs. The user may also be required to go through a setup process during which it identifies and enters other users whose PCs they will be using for making international phone calls.

For example, Jack, who has a PC 202 in the United States, may wish to make international calls to Poland. Jack has a friend in Poland, Mary, who has a PC 222 running the software. Then Jack will enter PC 222 in his setup. Jack may enter several PCs in his list for calling different countries, cities or area codes. Now, Jack may initiate an international phone call from his cell phone 210, for example with number (510) 246-9176, by first dialing a local number (510) 345-1234 of a landline 206 to which PC 202 is connected via modem port 204. The software of PC 202 may then request entry of an international number. Once Jack inputs, for example, the number +48618123456 of Mary's cell phone 230, the client software may then intelligently pick an appropriate PC in Poland, such as PC 222, from a list, based on the entered international phone number. Before making an internet call to the international PC 222, Jack's PC 202 may check if the international PC 222 is online. Optionally, Jack may have a list of multiple PCs for Mary's area code in order of preference. So if one PC is offline or busy, the next PC on the list may be used.

Once PC 202 makes an internet call to PC 222, and PC 222 picks up the call, then the international phone number may be transmitted. The international PC 222 then may initiate an outgoing call to the local number +48618123456. If Mary answers the call, the call is completed. The internet telephone call between the two PCs 202 and 222 may be achieved over a peer-to-peer connection between the two PCs 202 and 222, where no server is required to be involved once the call is in progress. The reverse call may also be initiated by Mary to Jack, by first dialing a local phone number, for example +48618123969 of landline 226, and then entering Jack's cell phone number.

In an alternative embodiment of the invention, phones 210/230 may be landline telephones instead of cellular phones. The landline for phone 210 may be local to landline 206, and the landline for phone 230 may be local to landline 226.

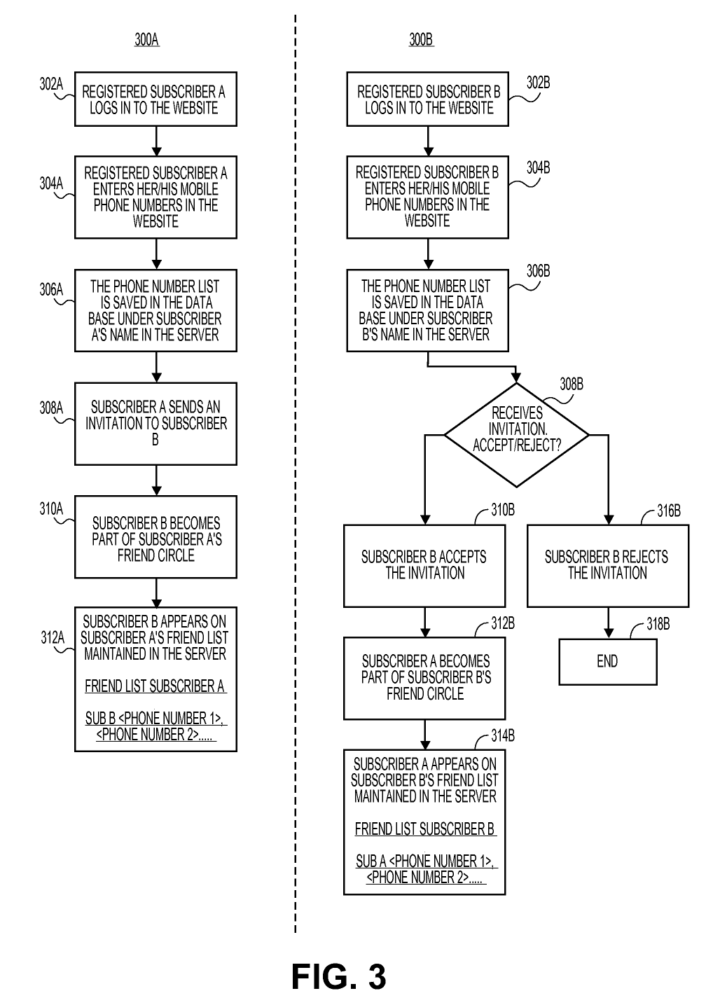

FIG. 3 illustrates flowcharts 300A-B of embodiments of the setup, edit, and management of a friends list with phone numbers by subscribers using, for example, a website. A registered Subscriber A may log in to the website at 302A. At step 304A, Subscriber A may enter his mobile phone number(s), or other numbers on which he would like his contacts to be able to reach him. These entered numbers are preferably numbers local to, of the same area code as, and/or in the same numbering scheme as, the number of the PSTN landline to which his PC's modem port is connected. This would allow Subscriber A to call the PSTN number, for example from his phone, and also allow his PC to dial his phone, at least expense.

At step 306A, the list of entered phone numbers is saved in the database under Subscriber A's name, or via another identification method such as an email address or username, in a server. Subscriber A may then send an invitation to Subscriber B at step 308A. Once Subscriber B becomes a part of Subscriber A's friend circle at 310A, Subscriber B and, optionally, B's respective entered phone number(s) may then appear on Subscriber A's friend list maintained in the server.

On Subscriber B's side, once logged in to the website at 302B, Subscriber B may at step 304B enter her mobile phone number(s), or other numbers on which she would like her contacts to be able to reach her. These entered numbers are preferably numbers local to, of the same area code as, and/or in the same numbering scheme as, the number of the PSTN landline to which her PC's modem port is connected. This would allow Subscriber B to call the PSTN number, for example from her phone, and also allow her PC to dial her phone, at least expense.

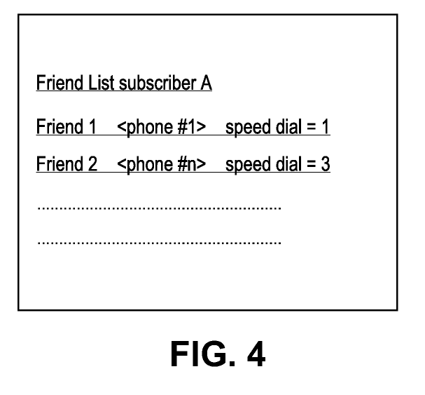

At step 306B, the list of entered phone numbers is saved in the database under Subscriber B's name, or via another identification method, in a server. Assuming that Subscriber B has received an invitation from Subscriber A, Subscriber B may accept or reject the invitation at step 308B. If she rejects at step 316 B, the process ends at 318B. If instead she accepts at 310B, Subscriber A becomes part of Subscriber B's friend circle at 312B. At step 314B, Subscriber A and, optionally, A's respective entered phone number(s) then appear on Subscriber B's friend list maintained in the server. In addition, subscribers may program speed dial numbers for particular friend phone numbers, as illustrated in FIG. 4.

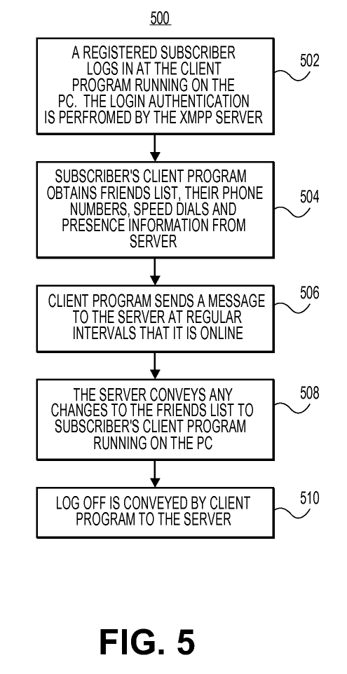

FIG. 5 illustrates flowchart 500 of an embodiment of real-time maintenance of a friends list and their phone number(s), by software executing on a client PC, with the help from, for example, an Extensible Messaging and Presence Protocol (XMPP) (e.g., IETF RFC 3920; see http://www.xmpp.org/; http://www.ietforg/rfc/rfc3920.txt) server. At step 502, a registered subscriber logs in at the client program running on the PC, and the login authentication is performed by the XMPP server. Then at step 504, the client program obtains the friends list, the respective phone number and speed dial entries, if any, and presence information from the server. This information may be maintained in the client software's working memory. The client may then at 506 send a message to the server, for example at regular intervals, indicating that it the subscriber is online. At step 508, the server may then convey any changes to the friends list, to the subscriber client program. These changes may be, but are not limited to, that a friend has gone offline/busy, that a new friend has been added, or that a friend has added/deleted/edited a phone number. If the subscriber logs off, the logoff is conveyed to the server at 510. The server may be configured to designate the subscriber as “inactive” if the subscriber's PC is turned off, or if its internet connection is no longer active. In such a case, no message is sent from the client program to the server.

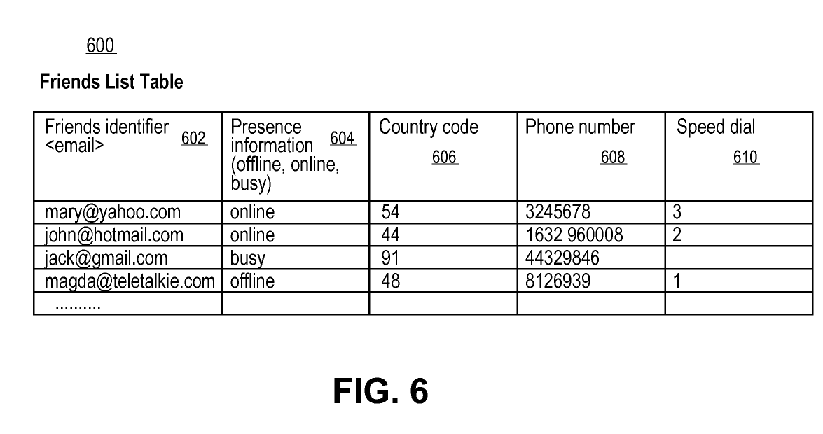

FIG. 6 illustrates table 600 with a sample friends list, including fields for identifier 602, presence information 604, country code 606, phone number 608, and speed dial 610. In this example, the identifier 602 for each friend subscriber is an email address, but it may be one of any method of identification, such as but not limited to a name or username. The friends list table 600 may be actively maintained in the PC client's memory and updated by information sent by the XMPP server if any changes are made, for example, through the website. For example, if a friend's presence status 604 changes, it may be conveyed to the PC client by the XMPP server. Presence status 604 indicators in this example include online, offline, and busy. As an example, “online” may indicate that the friend is logged in and accessible for phone calls; “offline” may indicate that the friend is not logged in or accessible; and “busy” may indicate that the friend is already in an active phone-call session or does not want to receive any calls at the moment. However, presence information is not limited to, nor required to include, the indicators or meanings as described above.

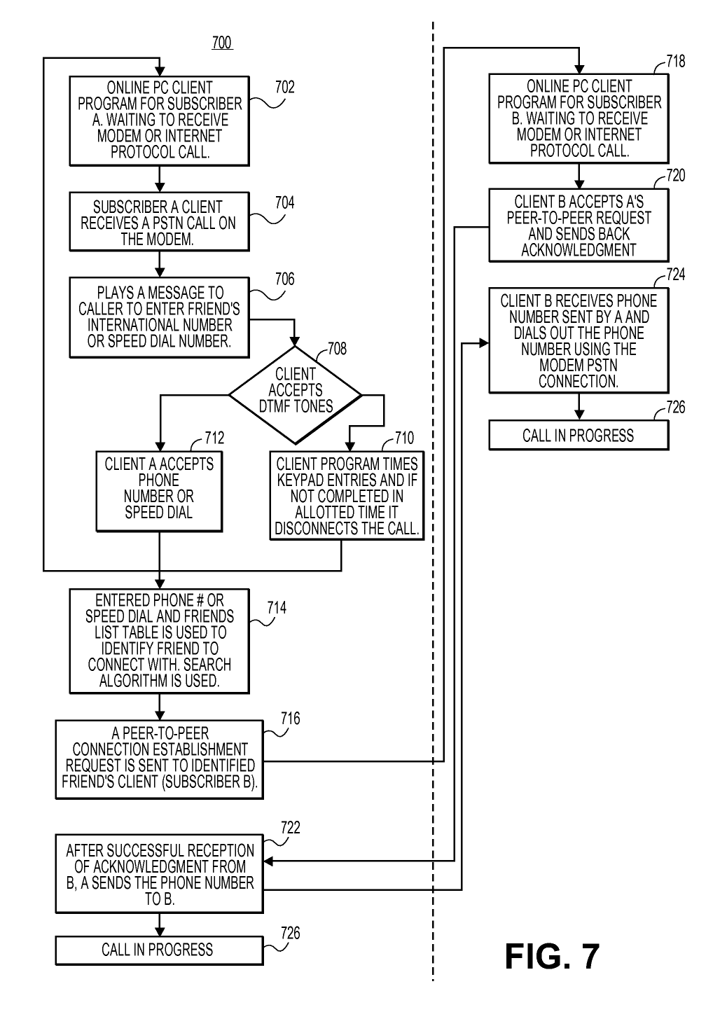

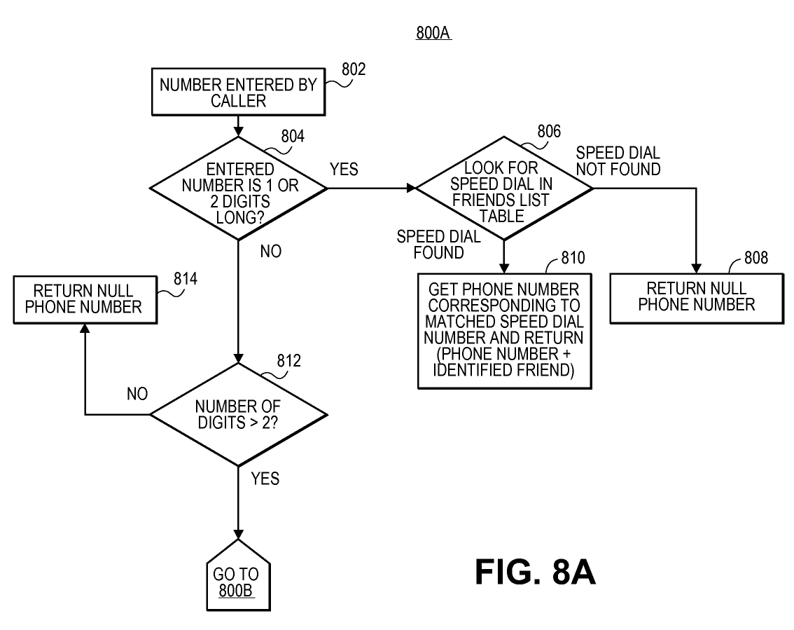

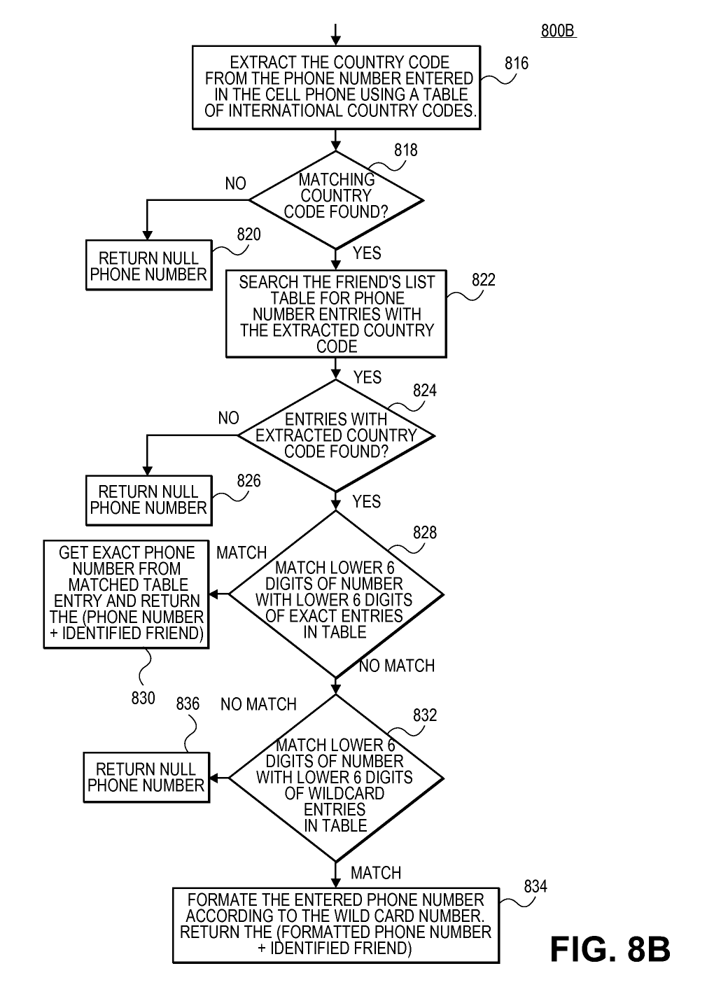

FIG. 7 illustrates a flowchart 700 of an embodiment of how a client program receives a phone number from a phone, such as a cell phone, and matches the number with a friend from the friends list. At step 702, an online client program for Subscriber A awaits a modem or Internet Protocol call. Subscriber A's client receives, for example, a PSTN call via the modem at 704, as a result of, for example, Subscriber A calling the landline from his cell phone. At 706, the client outputs a request to the caller (Subscriber A) to enter a long distance/international phone number, or speed dial number. The client accepts the DTMF tones at 708 as the caller inputs the respective numbers. At step 710, the client program may time the keypad entries, and if not completed in an allotted time, may disconnect the call or prompt the user again. The client program may optionally be configured to require entry of a symbol such as “#” to indicate completion of entry. If, however, the phone number or speed dial entry is accepted at 712, a search algorithm (described below in reference to FIGS. 8A-B) is implemented in 714 to determine, from the friends list, the friend in relation with the entered phone number or speed dial.

Once the friend, for example Subscriber B, is identified, a request for peer-to-peer connection establishment may be sent at 716 to the friend's client, which has been awaiting a modem or Internet Protocol call at 718. Once Subscriber B's client accepts A's request, it sends back acknowledgement at 720. Upon receiving this acknowledgement at 722, A's client transmits the long-distance phone number to B's client. Upon receiving this destination phone number at 724, B's client dials out the number using the PSTN modem connection, and if Subscriber B answers the phone, the call will then be in progress at 726.

An embodiment of a search algorithm, for identifying a friend subscriber based on the long-distance phone number or speed dial number entered by a caller, such as in step 714 of FIG. 7 as described above. Once a caller enters a number in 802, the client program may determine whether the entry consists of exactly one or two digits at 804. If so, the friends list is searched for a matching speed dial entry at 806. If a matching entry is found, the corresponding phone number and friend identifier is obtained in 810, and the information is returned. If no matching entry is found, indication of a null phone number is returned at 808. Upon receiving an indication of a null phone number, the client program may, but is not required to, include outputting a message to the caller to indicate the non-acceptance of the caller's previous entry, and/or a request and instructions for another attempt to enter a valid phone number or speed dial number.

If at step 804, it is determined that the entry is not exactly one or two digits long, it is then determined at 812 whether the entry consists of more than two digits. If not, indication of a null phone number is returned at 814. If so, the process proceeds as shown in flowchart 800B of FIG. 8B.

Flowchart 800B shows the process as it relates to determining the friend identifier corresponding to a non-speed dial number entry. Each phone number entry for a friend in a friends list may have been entered by the friend in one of two ways. First, the phone number may have been entered as an “exact” phone number or entry corresponding to the number to call a particular phone of that friend. Second, alternatively, the phone number may have been entered as an entry with wild cards, which can enable a caller to reach any one of the friend's phones within a single country code or area code. These entries are called “wild card” entries. Examples of such entries are:
a. Country code=44, phone number=**********. Such an entry will enable a caller to reach any one of the friend's phone numbers with the country code 44.
b. Country code=1, phone number=408*******. Such an entry will enable caller to reach any one of the friend's phone numbers with country code 1 and area code 408.
   The above types of entries would be stored in the subscriber's friends list.

At step 816, the country code is extracted from the entered phone number, using a table of international country codes. If no matching country code is found at 818, indication of a null phone number is returned at 820. If a matching code is found, the friends list is searched for phone number entries with the extracted country code. If not found at 824, indication of a null phone number is returned at 826. If found, a number of lower digits, for example, the lower six digits, of the entered number are matched at 828 with the same number of lower digits of exact entries in the friends list. If there is a match, the matched exact phone number and the corresponding friend identifier are returned at 830. If there is no match, a number of lower digits, for example, the lower six digits, of the entered number are matched at 832 with the same number of lower digits of wild card entries in the friends list. If there is no match, indication of a null phone number is returned at 836. If there is a match, the entered phone number is formatted at 834 according to the wild card number. The formatted phone number and friend identifier are then returned.

FIG. 21 illustrates an embodiment of a process by which the client software picks up an incoming call. Upon receiving an incoming call at 2102, the client software begins counting the number of rings. In the flowchart, “n” represents the number of actual rings, and “N” represents the number of rings, set by the user, after which the software is to pick up a call. If n=N at 2104, the software may “answer” the call by, for example, playing a message to request keypad entry of a user selection. For example, the message may ask the user to “Press 1 for voicemail; Press 2 to be connected to the home phone line; or Press 3 to make an international call.” The DTMF tone from the user's entry is then gathered at 2108. If “1” is selected, the system may enter into the voicemail path at 2110, and request the user to record his voicemail. The user's voice may then be recorded at 2112, optionally for up to a time limit, such as 2 minutes. The recording is then ended at 2114 when the time limit is up, or when the user hangs up the phone.

If “2” is selected, the software may then ring the home line at 2116, for example, via the home PC's speakers. The ring may be limited to a number, such as 4 times, or until the phone is picked up. If “3” is selected, the software may request the user to enter the international number at 2118, optionally followed by an indication of entry completion such as the “#” sign.

If at step 2104, the number of rings n has not reached the number of rings set for pick up N, the client checks to see if the line has been answered by another device at 2120. If not, the process loops back to 2104 to check on the number of rings. If the line has been answered, such as by an individual at home, a fax, or voicemail, the PC client may pick up the call at 2122 and play, for example, a shrill beep as a signal. The client may then wait for a potential DTMF tone followed by, for example, a “#” sign. The wait may be limited, such as up to 30 seconds. If an appropriate entry is received at 2124, the client may proceed to the international calling procedure at 2126. Otherwise, if the wait has not yet been 30 seconds at 2128, the client continues to wait for an appropriate entry. If the wait has been 30 seconds, the client hangs up at 2130 and allows the device which answered the call to continue at 2130.

In an embodiment of the invention, a home PC may serve as a hub for communications not only for the owner/family of the PC, but also for a community set up by the PC owner, serving as a “Service Provider.” The Service Provider may require payment from members of the community for this service, and the payment scheme may be implemented via one of various methods known to one of ordinary skill in the art. The Service Provider may elect to restrict the service to particular days and/or times. The service may be offered for a particular country code and/or area code. Service Providers may also allow customers to rate their services, such as based on the quality of the call, availability of service and call drop. Those service providers endeavoring to embark on a serious business venture may employ a telephone card with multiple modem ports, and multiple calls can be enabled via multiple telephone lines.

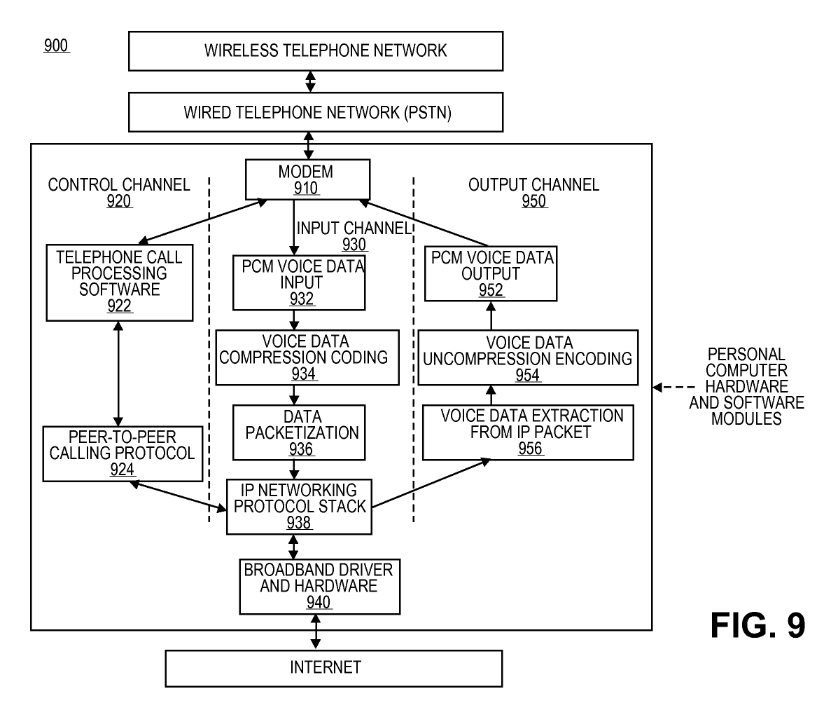

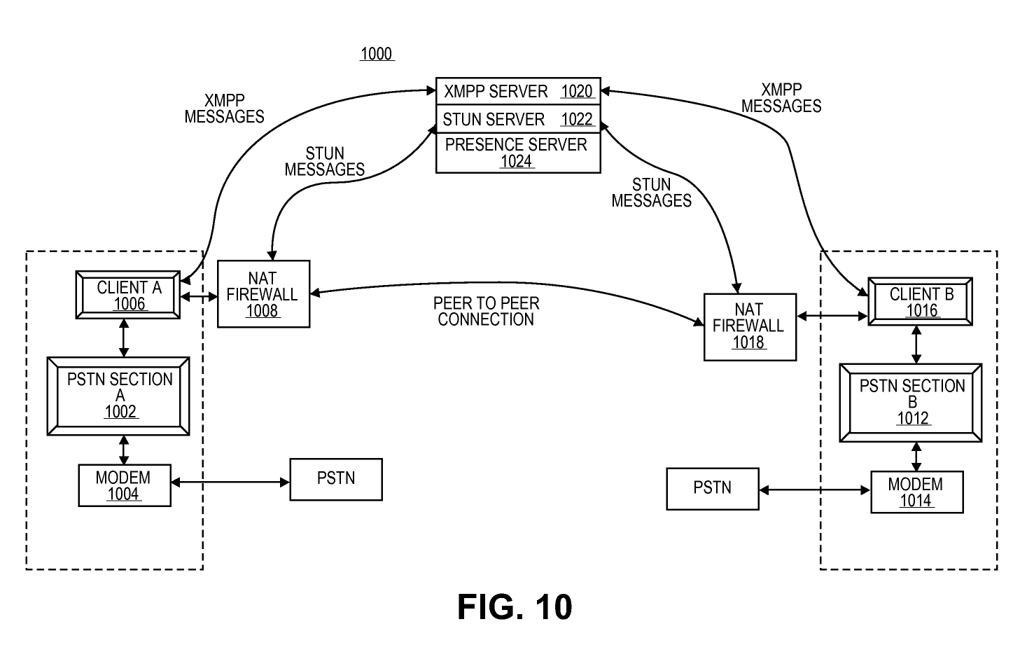

FIG. 9 shows an embodiment of a system 900 of the different hardware and software modules involved in the processing, switching and communication of the telephone call made through the invention. The control channel 920 is responsible for receiving and initiating telephone calls. It is also responsible for initiating and receiving Internet Protocol (IP) calls from another international PC running the same system. The input channel 930 is responsible for receiving voice data from the analog telephone line, digitizing it, putting it into IP packets and sending it over the internet to another international PC running the same system. The output channel 950 is responsible for receiving IP packets containing voice data from another PC on the internet. It then extracts the voice data and sends it out on the analog telephone line.

The telephone Modem 910 is the interface between the analog telephone line and the software modules in the system. If a telephone call is being received, then the modem signals that information to the Telephone Call Processing Software (TCPS) 922 module. The TCPS module 922 then picks up the call and puts the modem 910 in a voice or DTMF tone data transfer mode. The PCM Voice data input module 932 reads pulse code modulated digital data from the modem 910 and transfers it to the Voice Data Compression Coding unit 934. This unit 934 performs compression on the voice data so that it can be efficiently transmitted using IP packets over the internet. The compressed voice data is segmented and put into IP packets by the Data Packetization module 936. Then the IP Networking Protocol Stack 938 in the PC's operating system is used. The broadband driver and hardware 940 for the PC's internet connection (e.g., DSL, Cable) is used to send the bits of digital data over the physical wires. The TCPS unit 922 after receiving the cell phone call may then call the PC on the other end using the Peer-to-Peer calling Protocol module 924. Once an internet call is established with the PC on the other side, the PC on the other side starts sending digital voice data encapsulated in IP packets to the present PC. It is received by the IP Networking Protocol Stack 938 in the operating system of the PC. Voice data is extracted from the IP packets by the Voice data extraction from IP packet module 956 and then encoding at module 954 is performed on the compressed data in order to extract PCM digital voice data. The PCM data is then sent at module 952 to the modem 910 and is transmitted over the analog telephone lines to the telephone network. In this manner, the telephone call is established and the telephone conversation proceeds. Termination of the call occurs when the calling or called phone hangs up. The action of hanging up is signaled by the modem 910 to the TCPS 922. The TCPS 922 then disconnects the modem 910 and initializes the Input 930 and output 950 channels. It also signals the call termination event by special control IP packets to the other PC, which then disconnects its modem from the cell phone call. The other PC also initializes its Input and Output channels. The input is again in a state to receive a new telephone call.

In an embodiment of the invention, the product architecture 1000 has two major sections. One section 1002/1012 establishes communication and exchanges data with the Public Switched Telephone Network (PSTN). Another section establishes communication and exchanges data with a peer PC connected to the internet by a broadband connection. The PSTN section 1002/1012 of the product uses a PC analog modem 1004/1014 and telephone signaling to receive and initiate calls from and to the PSTN. After call establishment, voice and tone data transfer is performed from the PC via the modem 1004/1014 to and from the PSTN.

Client software 1006/1016 installed on users' PCs establishes peer-to-peer connections. An XMPP server 1020 helps in the establishment of such connections. A Simple Traversal of UDP over NATs (STUN) (e.g., IETF RFC 3489; see http://www.ietf.org/rfc/rfc3489.txt) server 1022 is used to find the internet addresses and ports on which the user PCs are reachable. A Presence server 1024 constantly provides latest information about a user's FriendCircle and ServiceProvider list. Once the peer-to-peer connection is established between the client software 1006/1016 running on the PCs, no server intervention is needed. Voice data is exchanged directly between the two PCs. The peer-to-peer software library will be used for the peer to peer protocol. The library provides seamless peer-to-peer connection establishment between two PCs across NAT devices and firewalls 1008/1018. The system diagram 1000 shows how the two PC clients A and B establish peer-to-peer connectivity through NAT firewalls 1008 with the help of the central server.

The system works in a client-server environment. The client piece of the software 1006/1016 executes on the home PCs of registered users. It has all the components which make it possible to make and receive PSTN calls and Voice Over IP internet calls. The server components of the system execute centrally on the company's computers and provide several services to the clients. Services such as user registration, user login, presence detection of registered users may be some of these services. During the establishment of a peer-to-peer connection, the initiating PC takes the help of the STUN 1022 and XMPP 1020 servers to make such connections.

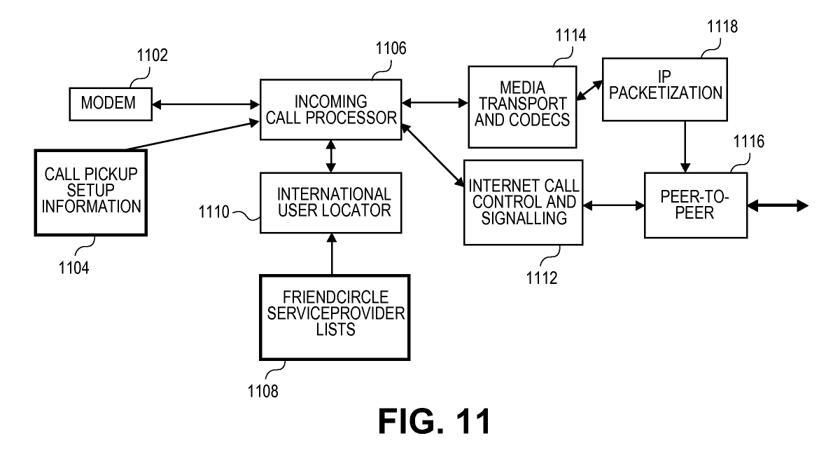

FIG. 11 illustrates the client architecture according to an embodiment of the invention, from the point of view of incoming telephone call processing. The modem port of the PC is connected to the telephone jack in the home. Any incoming call made to the home telephone number can be received by the PC software modules. A telephone call made to the home telephone number from a mobile phone is received via the modem 1102 port and then the Incoming Call Processor 1106. After receiving the incoming call, the Incoming Call Processor 1106 sends out a beep tone to the mobile phone caller signaling the caller to enter the international phone number. The mobile caller then enters the international phone number, which is received and stored by the Incoming Call Processor 1106. This international phone number is then forwarded to the International User Locator module 1110. The International User Locator 1110 then performs an algorithmic search through the FriendCircle ServiceProvider Lists 1108. If an active and successful international user is located the result of the search is signaled to the Incoming Call Processor 1106. The search information is then forwarded to the Internet Call Control & Signaling unit 1112. It then, using the Peer-to-Peer module 1116, tries to establish a peer-to-peer connection with the international user's PC. After a successful peer-to-peer connection has been established, voice data flow starts from the modem 1102 passing through the Media Transport & Codec unit 1114. In the data path, functions such as noise reduction, echo cancellation and compression may be performed on the outgoing voice data. The data is then packetized in the Internet Protocol (IP) format at module 1118 and sent out over the internet connection.

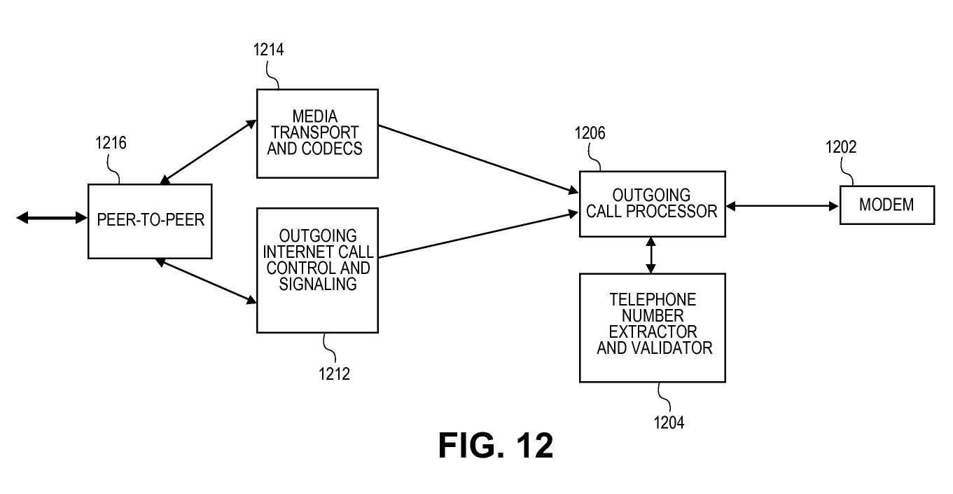

FIG. 12 illustrates the client architecture according to an embodiment of the invention, from the point of view of outgoing telephone call processing. The outgoing call processing function includes receiving a Voice Over IP (VOIP) call from the other user's PC by the Peer-to-Peer unit 1216. The Outgoing Internet Call Control & Signaling 1212 acts in conjunction with unit 1216 to receive such calls from the internet. The mobile phone number which is received from the other end over the internet connection is forwarded to the Outgoing Call Processor 1206. This telephone number is then validated and reformatted according to local rules, by the Telephone number extractor & validator 1204. The Outgoing Call processor 1206 then initiates a local telephone call to the local mobile telephone using the PC modem 1202. If the call to the local mobile phone is successful then a data connection is established. Voice data is then received from the local mobile phone through the modem and forwarded via the Media Transport & Codecs 1214 to the user on the other side of the internet peer-to-peer connection.

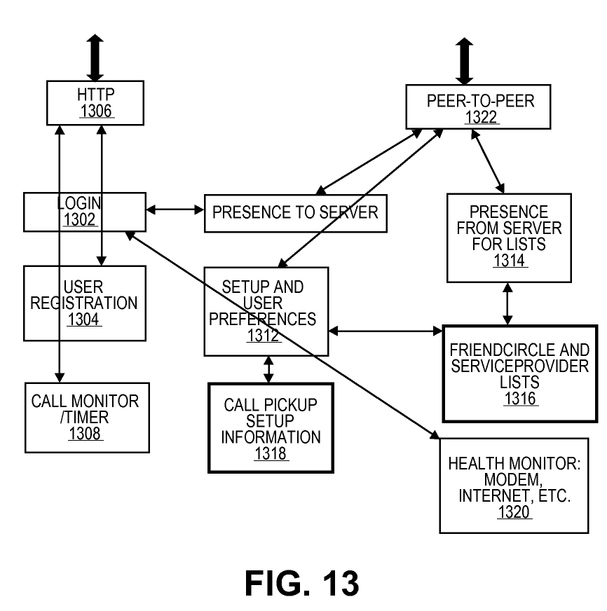

FIG. 13 illustrates the administrative and management components according to an embodiment of the invention. Central servers, maintained by the company, maintain the list of registered users. Once a user's PC is on, or the user logs in to his or her account, this information is updated and maintained on the company's server. The PC software executes the login client software 1302 and the software module 1310 which periodically informs the company server that it is active. This module is called the Presence to Server module 1310. The PC also periodically inquires about its FriendCircle & ServiceProvider Lists 1316 from the company server. This is performed so as to determine whether other users are active so that a VOIP call can be initiated. This operation is performed by the Presence from Server for Lists module 1314.

After the software is downloaded from the company server, the User Registration unit 1304 is used to create a registered user on the company's user base. This is located in the central company's server. The Health Monitor unit 1320 periodically checks whether all connections, such as the internet connection and the phone modem connection, are active and functioning. Using the Setup & User preference module 1312, the user can create a list friends whose PCs will be used for international telephone calling. Certain preferences, such as but not limited to when the PC will pick up an incoming call, for example after 3 rings or 6 rings, can be programmed by the user into the Call Pickup Setup information unit 1318.

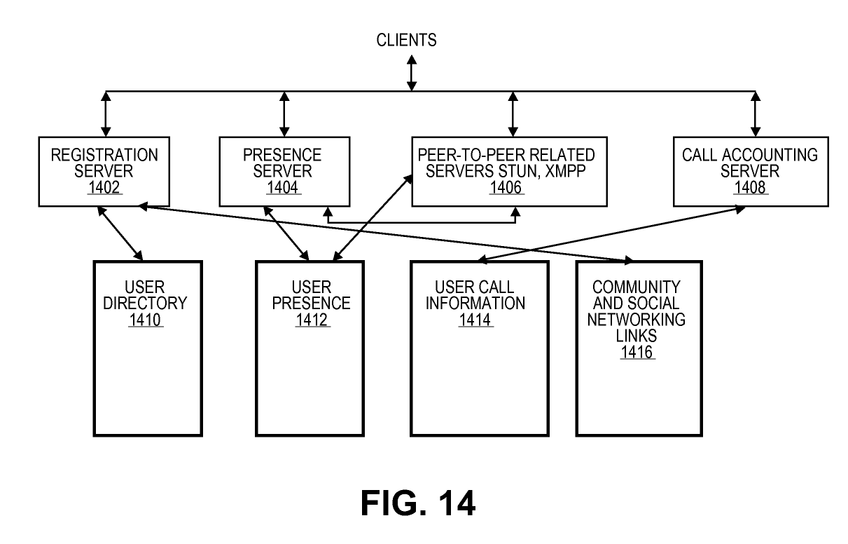

FIG. 14 illustrates the server architecture according to an embodiment of the invention. The servers may be software components running on the company's computers, and personal computer clients from all over the world may interact with these server programs. The Registration server 1402 is used to create first time users. Using this server, new users may create their accounts and later on modify their accounts. The User Directory database 1410 is created by the Registration Server 1402. Server 1402 may also maintain community and social networking information 1416.

All personal computer clients may log in using the Presence Server 1404. Personal computer clients also periodically inform the Presence Server 1404 about their active status. The Presence Server 1404 maintains a list of active users in the User Presence database 1412. All PC clients may also periodically get information regarding their Friend List active status from the Presence Server 1404. The Presence Server 1404 works in conjunction with an XMPP server to determine such presence information of registered users.

Peer-to-Peer related servers 1406 help in the establishment of peer-to-peer connections between PC clients. These servers 1406 maintain IP addresses and information about clients and how they can be reached by other clients. The STUN server enables applications to determine the type of NAT (Network Address Translation) devices or Firewalls that are between the client PC and the internet. It also provides the capability to determine the internet IP of clients as allocated to them by the NAT devices or firewalls. In order for a client PC to establish a peer-to-peer connection with another client behind a NAT device or a firewall, it must obtain the information about the client from the central STUN server. The XMPP server runs a protocol to determine the presence information, active or inactive, of the registered clients.

The Call Accounting Server 1408 is responsible for maintaining the information database 1414 about completed calls between users. Call details, such as but not limited to the calling party, called party, time and date of a call, and duration of a call, are stored using this server.

Thus, the embodiments of the invention described above enable the creation of a worldwide network of mobile phones and devices using inexpensive home personal computers (PCs) connected to the internet and the Public Switched Telephone Network (PSTN). Because of the pervasive deployment of the internet worldwide, and the availability of PCs in many homes, this invention enables mobile phone users to make free or very inexpensive long-distance or international calls. The invention also allows users to move freely and make calls from anywhere and everywhere using their mobile phones, without being tied down to a computer.

Another embodiment of the invention also enables a user a convenient and inexpensive method of making calls to and receiving calls from business associates, friends and family members located, for example, in the relative vicinity of a traveler's home residence. Since these days, almost every business traveler carries a laptop, and broadband or WIFI connections are available nearly universally, the call can be made from almost anywhere.

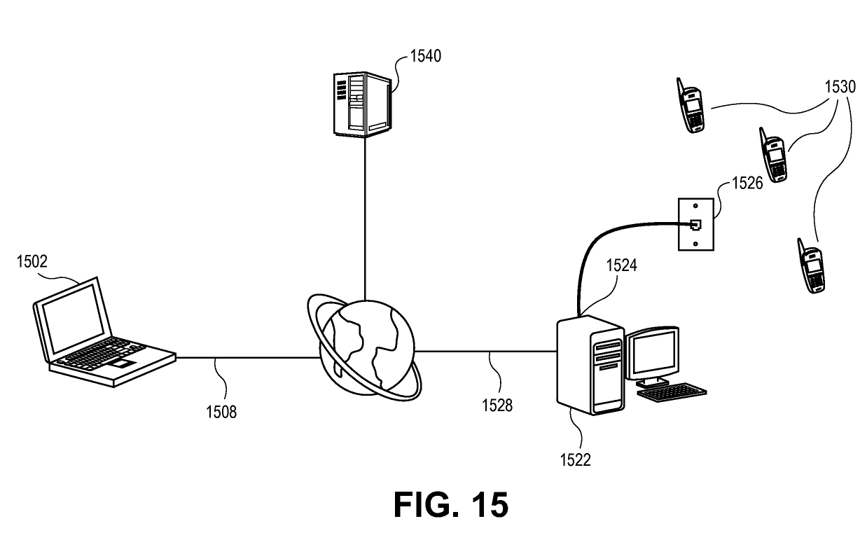

For example, as illustrated in FIG. 15, a “Roaming” portion of the client software may execute on the traveler's laptop 1502 and provide a friendly interface, such as a virtual keypad, to dial a phone number from the screen. Prior to travel, the traveler should set up his home PC 1522 so that it is connected to the internet using a broadband connection 1528, and so that the PC analog modem 1524 is connected to the home PSTN telephone line 1526. The home PC 1522 should also be executing the “Base” part of the software.

While the traveler is, for example, out of the country, and he dials a phone number from his laptop 1502, the Roaming software captures the number and establishes a peer-to-peer connection with the traveler's home PC 1522 Base software, via server 1540 located, for example, at a company. The Roaming software then transfers the entered phone number to the Base software executing on the home PC 1522. The Base software then dials out the phone number over the PSTN line 1526. The phone 1530 on the other side picks up, the call is established, and the conversation proceeds by the transfer of UDP IP packets containing digitized voice data. The traveler may use the laptop's microphone and speakers for the audio conversation. The cost of, for example, an international call may thus be reduced to the cost of, for example, a local call (or a long-distance domestic call) from landline 1526 to phone 1530 which in many cases is free and part of the calling plan of the subscriber, or at least much less expensive than the cost of an international call. In other words, the international portion of the call may be rendered completely free of cost, reducing the call cost to that of the PSTN portion of the call, from home PC 1522 to telephone 1530.

The traveler can also receive a call from the home region on his/her laptop using the method above, implemented in the reverse direction. When anybody calls the traveler's home telephone number on line 1526, the Base software executing on the traveler's home PC 1522 may be configured to pick up the call. Then the Base software originates an internet call to the traveler's laptop 1502. If the traveler's laptop 1502 is powered and executing the Roaming software, a peer-to-peer connection may be established between the two PCs. The Roaming software may initiate a ringing sound on the laptop using the speakers, and optionally display the phone number of the calling party, to alert the traveler about an incoming call. If the traveler picks up, such as via a mouse click or keystroke, the call is established and conversation proceeds using the laptop's microphone and speakers. Should the laptop be offline or inactive, the system may be configured to allow the calling party to leave a voicemail which is, for example, recorded at the home PC and later played when the laptop's Roaming program becomes active.

In an embodiment of the invention, there are three major components to the working of this invention. The Base component which executes on the user's home PC is comprised of the PC modem connected to the PSTN network, software modules to handle PSTN calls, and software modules to handle internet IP calls. The Roaming component executes on the traveling user's laptop is comprised of the microphone and speaker sound hardware of the laptop, software modules to provide a user interface to make and receive calls, and software to handle internet IP calls. The third component is the “Server” which executes on, for example, computers in the company. The Server includes components to facilitate the establishment of a peer-to-peer connection between the laptop and home PC. It may be comprised of a XMPP server and STUN server. Another server module may keep track and records call details for every call made by all users.

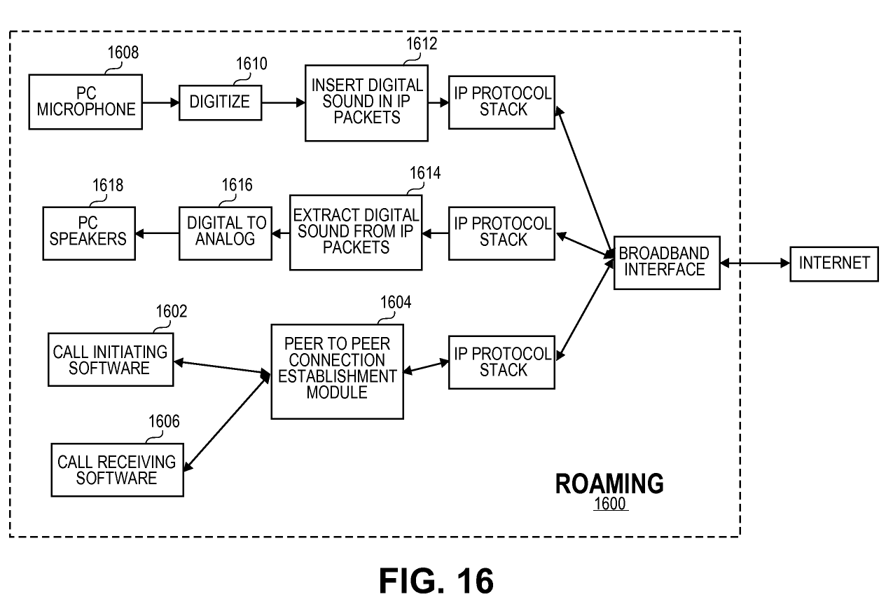

The Roaming module executes on the traveler's laptop. The software provides a Graphical User Interface (GUI) to the user for making and receiving calls. FIG. 16 illustrates the functional blocks for the Roaming module 1600 in an embodiment of the invention.

The Call Initiating Software 1602 provides a keypad GUI for entering the phone number to be dialed. The user may, for example, enter the phone number using the keypad and click on a key or button to indicate call initiation. Upon this action the Peer-to-Peer Connection Establishment module 1604 tries to establish a connection with the Base component executing on the home PC. The Server component executing on the company's computers provides information for establishing this connection. Once the connection is established the entered phone number is passed on to the Base component. The Base component, after checking phone number validity, dials out the number on the PSTN line. The dialed phone picks up and the conversation proceeds. The laptop traveler speaks into the microphone 1608, the voice data is digitized at 1610 and inserted into the IP UDP packets at 1612 and sent over the already established peer-to-peer connection to the Base component. UDP packets received from the Base component has the digital voice data extracted from the packets at 1614, and after digital to analog conversion at 1616 is sent to the laptop's speaker interface 1618. In this way a normal voice call proceeds.

When a call is being received by the traveling user the Base module establishes a peer-to-peer connection with the Roaming module. The Call Receiving Software 1606 is triggered. It receives the caller's ID and may display it on the screen along with a ringing sound. The traveling user can decide to pick up the call by, for example, clicking on the GUI button or decide to ignore the call by, for example, clicking on a different button. In a successful call, the voice data paths may be the same as previously described regarding a call initiated by the traveler.

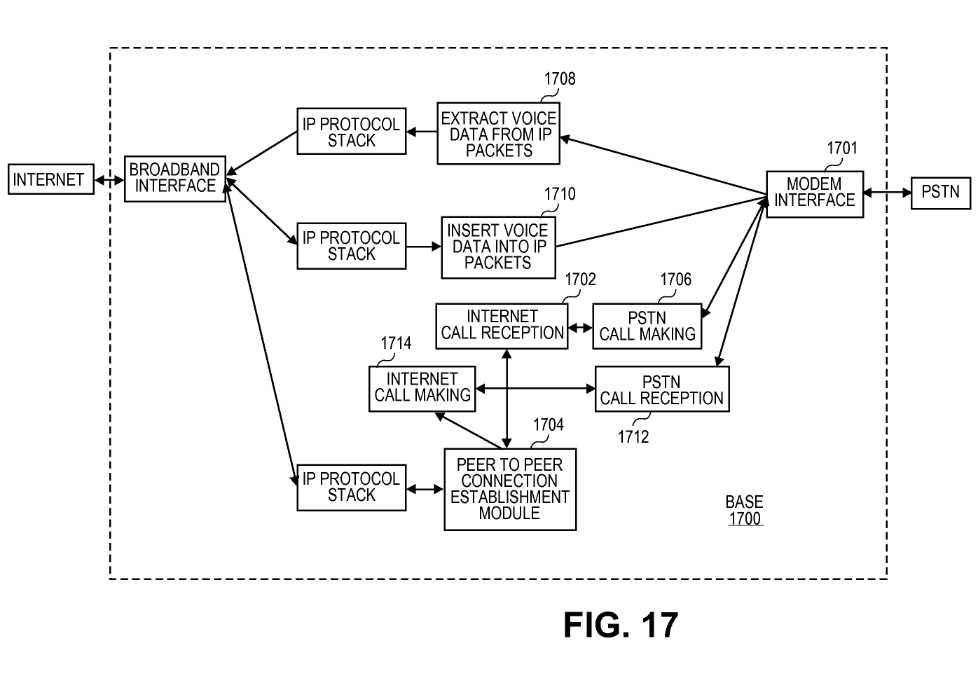

The Base module software executes on the user's home PC and may be required to be constantly running. It provides the traveling user with an extension of his/her local calling plan when abroad. FIG. 17 shows the functional blocks of the Base component 1700 in an embodiment of the invention.

When the traveling user makes a call from his/her laptop, the Internet Call Reception module 1702 is responsible for negotiating during the establishment of the peer-to-peer connection at 1704. Once the peer-to-peer connection is established, the dialed phone number is received from the Roaming component. The PSTN Call Making unit 1706 then dials out using the modem interface 1701. If the phone picks up, the call is established. Voice data received over the peer-to-peer connection in UDP packets is extracted at 1708 and then transmitted over the modem interface to the phone at the other end. On the receiving side, digital voice data is read from the modem interface and packed into UDP packets at 1710 and sent over the peer-to-peer connection to the Roaming component.

When a call is being received by the traveling user, the PSTN Call Reception unit 1712 triggers the Internet Call Making module 1714, which negotiates during the establishment of the peer-to-peer connection at 1704 and makes an internet call to the laptop. If the traveler picks up the call via his laptop, the call is established. In a successful call, the voice data paths may be the same as previously described regarding a call initiated by the traveler.

The Server module, which may include one or more servers running on one or more of the company's computer(s), provides information to the Roaming and Base modules to establish peer-to-peer connections. An XMPP (Extensible Messaging and Presence Protocol) server may be responsible for maintaining the presence information of all Roaming and Base modules. All Roaming and Base modules may report to the XMPP on a regular basis so that the current online status of these modules is kept up to date in the XMPP server. A STUN (Simple Traversal of User Datagram Protocol (UDP) Through Address Translators (NAT)) server may provide information to the peers on how to reach another peer over the internet in order to establish a peer-to-peer connection. After the completion of every call, the Base module may report on the status details of the call, such as but not limited to user name, phone number dialed, duration of call, success, and voice mail to a call accounting server.

Thus, the invention of the system may enable any international traveler with a laptop and a broadband connection to make free or low-cost phone calls to his/her local home region. The traveler has the advantage of using the same local low-cost calling plan without the need to subscribe to any expensive international calling plan. Because of the pervasive deployment of the internet worldwide and the availability of PCs in most homes, and the use of laptops by a large number of business travelers, this invention is very significant in its ability to provide the traveler a free international connection.

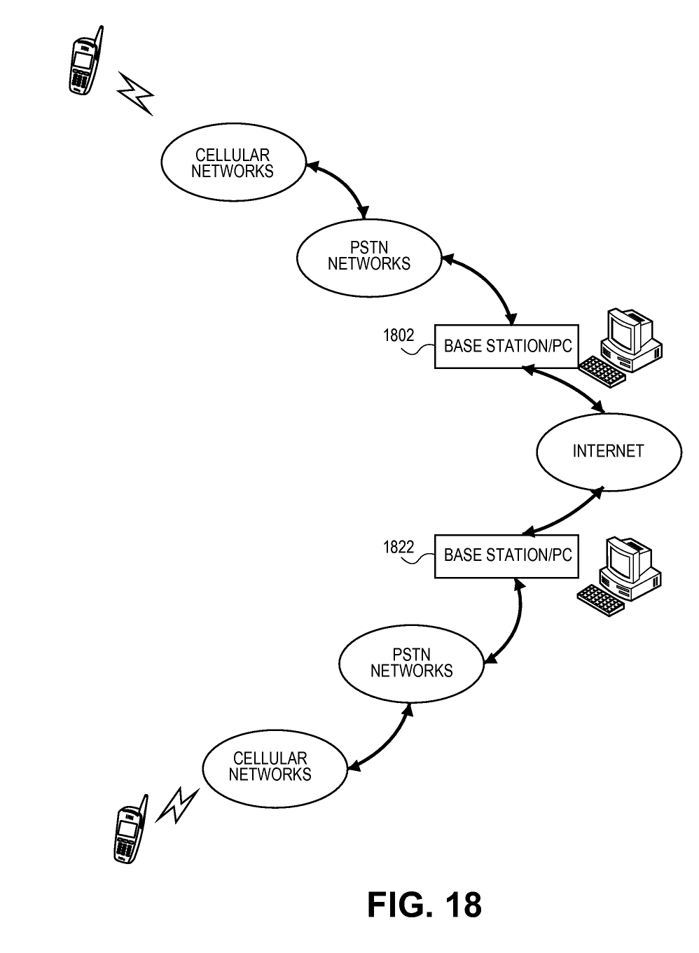

In another embodiment of the invention, one or more computers, such as 202/224 of FIG. 2 or 1502/1522 of FIG. 15, may be substituted with a “base station” device, as described herein below. A base station may be a more suitable device for some individuals, for example, who do not own or cannot afford a computer, or who own a computer with specifications that are unable to support an implementation of the invention. FIG. 18 illustrates an embodiment of the invention similar to that of FIG. 2. However, the device 1802/1822 may be a base station instead of a computer. In addition, this substitution may also be implemented in the context of the embodiment shown in FIG. 15.

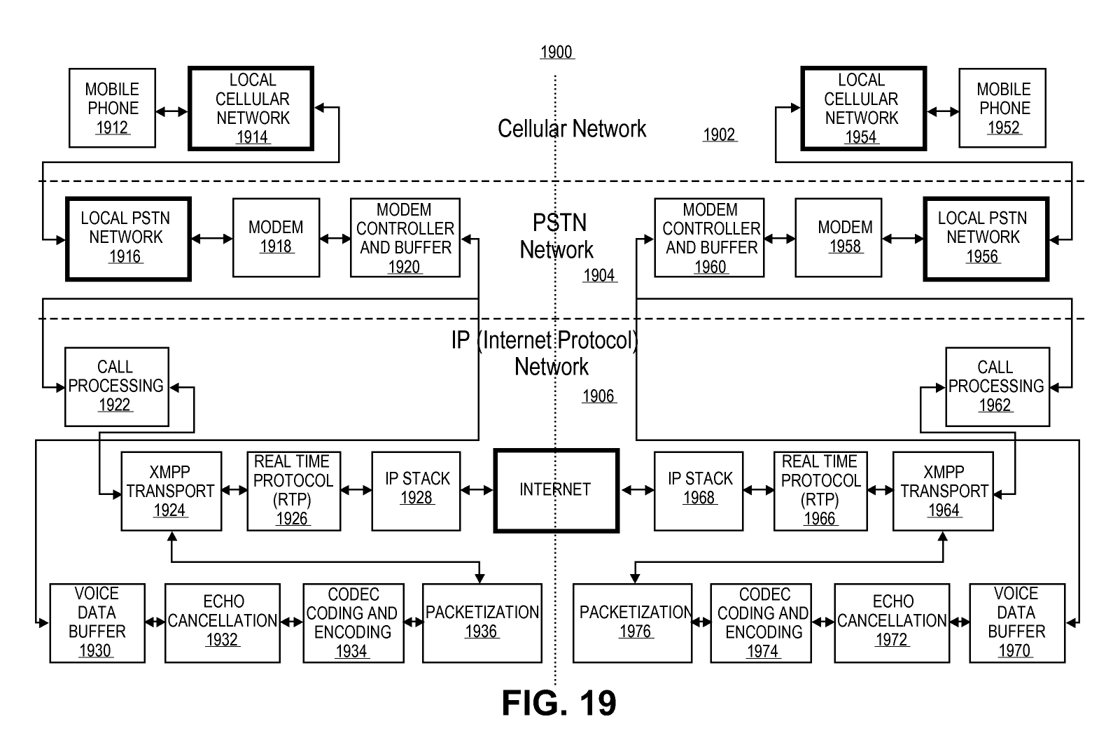

FIG. 19 illustrates an international mobile network 1900 using a user's subscribed cellular network 1902, PSTN network 1904 and the internet provider 1906, according to an embodiment of the invention. The origin and destination devices, which may be a base station and/or computer, execute the software components. Initially, a calling party initiates a call from a telephone, such as mobile phone 1912, to the home landline. The call progresses through the cellular network 1914 and the PSTN (Public Switched Telephone Network) network 1916 to the home landline. The analog dialup Modem 1918 picks up the call. The mobile phone user then enters the destination phone number which is received by the modem 1918 using DTMF (Dual Tone Multi Frequency) tones. Module 1920 contains receive and transmit buffers of the modem. Analog data from the modem is converted to digital form and stored in the buffers on the way in and out. The Call Processing module 1922 establishes a peer-to-peer connection with the destination device and sends the destination phone number to the destination device. All transfer of control data happens using the XMPP Transport 1924 and Internet Protocol (IP) stack 1928.

The destination device receives the destination mobile phone number. The modem 1958 on the destination device then calls out using this destination mobile phone number. The call progresses through the PSTN network 1956 and the cellular network 1954 to the destination mobile phone 1952.

During the call, voice data is read from the modem and buffered in the voice data buffer 1930/1970. In transmit mode, there may be two data buffers, a modem-data buffer and a microcontroller-data buffer, implemented in the modem controller RAM and microcontroller RAM by main controller. When the voice control DSP engages voice operation, it will send a block of data in regular time periods, such as every 20 ms, to the main controller circuit through dual port RAM.

Echo cancellation is performed at 1932/1972. Echo cancellation may alleviate any echo noise by measuring the echo delays and magnitudes allowed the modem to tell if the received signal was from itself or the remote modem, and create an equal and opposite signal to cancel its own. The delays and magnitudes may be measured in the beginning of signaling for milliseconds; then the delay and weighted shall be assigned. The received data may be subtracted from the delay and weighted value to remove the echo noise.

The voice data is encoded at 1934/1974 in order to compress it, packetize it at 1936/1976, and sent over to the destination PC. The RTP protocol 1926/1966, XMPP transport 1924/1964 and the IP stack 1928/1968 is used to send it over the internet. For example, the Conexant Host-Processed High Definition Audio (HDA) Modem Codec (MC) Device Set with Conexant's fourth generation SmartDAA 4 technology supports V.92/V.90 analog receive data up to 56 kbps with V.44 data compression, V.17 analog fax to 14.4 kbps, voice/telephone answering machine (TAM), and HDA interface operation. The modem operates with PSTN telephone lines worldwide.

At the destination PC the packetized voice data is decoded and sent over the modem and the networks to the destination mobile phone.

Following are two example scenarios describing the technical implementation using a base station hardware module. In a first local-phone-to-VOIP scenario, User 1 connects to the server and provides the connection details/phone details of User 2 to the server, and then gets connected to User 2 via the base station using the IP network. This connection data is then forwarded to the local phone instrument. Similarly, from the local phone line connected to the base station, a user can perform a VOIP call to other users registered with the server. A call manager in the VOIP stack and codec will handle the communication with the server.

In a second PSTN-to/from-VOIP scenario, User 1 connects to the server with User 2 details, such as the base station identification number and destination phone number. It gets connected on IP network via the base station with User 2's side, and then using the PSTN port it is transferred to the desired PSTN phone number. Similarly, User 2 may calls the base station using a specific PSTN number. The base station will forward this call to the desired VOIP number registered with the server.

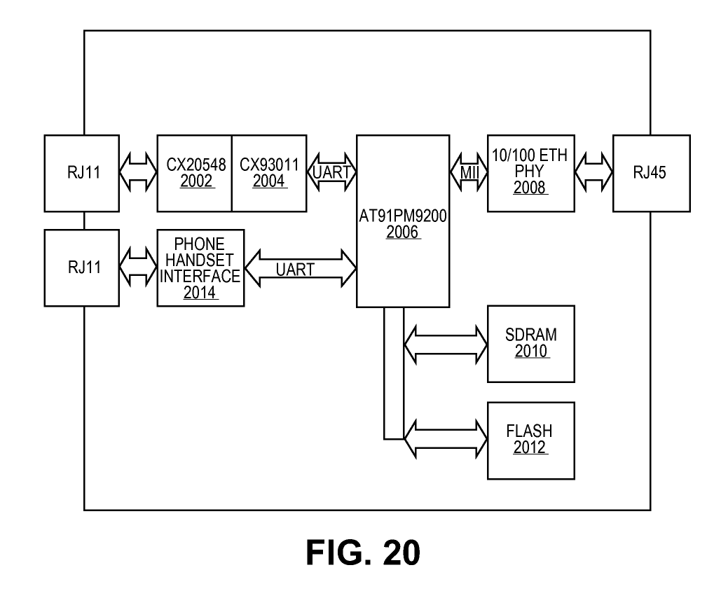

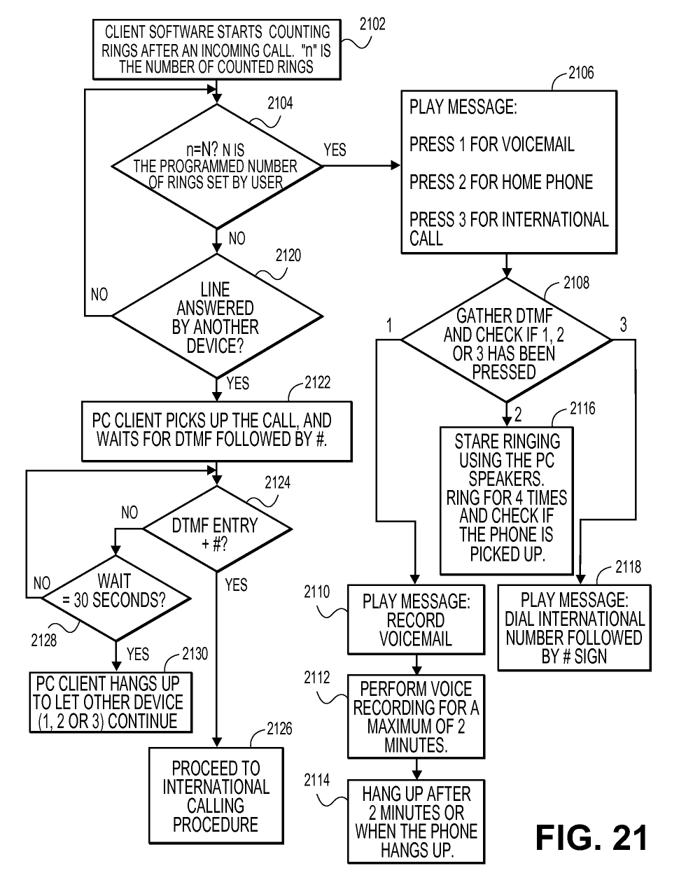

FIG. 20 illustrates a block diagram of an embodiment of the base station hardware module. The base station may perform the same function as that of a personal computer in the embodiments of the invention described above. In this example, the hardware is based on ARM9 platform, but the invention is not limited as such. The base station executes the bridging function between the Public Switched Telephone Network (PSTN) and Internet VOIP by converting data of the analog telephone line to IP packets through the modem interface and 10/100 Ethernet. The 10/100 Ethernet PHY 2008 shall connect to the internet using a broadband connection like DSL or cable modem. The Public Switched Telephone Network (PSTN) shall connect the mobile phone through a cellular phone network.

The telephone Modem of both CX20548 (analog controller 2002) and CX93011 (digital 2004) form the interface between the analog telephone line from PSTN, and the VOIP modules in the system. The 10/100 PHY is the connection to the VOIP in the Internet after the data packetization is performed by the system in the base station.

The main components of the base station include a Conexant modem chip 2004, modem analog controller 2002, phone handset interface chip set 2014, ARM9 microcontroller 2006 with MII Ethernet port, Flash 2012, and SDRAM 2010. This device set consists of a CX93011 V.92/V.34/V.32bis Modem device in a 20-pin QFN and a CX20548 SmartDAA® 4 Line Side Device (LSD) in a 16-pin QPN. The CX93011 modem device 2004 integrates an ARM9 microcontroller (MCU), a digital signal processor (DSP), internal RAM, internal ROM, and a SmartDAA system side device (SSD) onto a 20-pin QFN. The CX93011 connects to the host over a serial interface. The CX20548 SmartDAA 4 LSD includes a Line Side DIB Interface, a coder/decoder (codec), and a Telephone Line Interface (TLI). The Line Side DIB Interface communicates with, and receives power and clock from, the SmartDAA 4 interface in the host side device (HSD) through the DIB transformer. The TLI integrates DAA and direct telephone line interface functions and connects directly to the line TIP and RING pins, as well as to external line protection components.

The software components of the base station include Embedded Linux, IP stack, XMPP-Libjingle (see http://code.google.com/apis/talk/libjingle/index.html) communication stack, RTP communication stack, STUN client, Speex CODEC (see www.speex.org), and application software. Embedded Linux is required with implementation of TCP/IP protocol stack that provides Internet connectivity to embedded microcontroller with 32-bit ARM instruction set. The Broadband driver and hardware for the base station internet connection (e.g., DSL, Cable) is used to send the bits of digital data over the 10/100 Ethernet physical wires to the Internet router. The TCPS unit after receiving the cell phone call has to call the base station on the other end using the Peer-to-Peer calling Protocol module. Once an internet call is established with the base station on the other side, the base station on the other side starts sending digital voice data encapsulated in IP packets to our base station. It is received by the IP Networking Protocol Stack in the operating system of the base station.

The physical ports of the base station include a modem port for connection to PSTN, 10/100 Ethernet port for connection broadband Internet, telephone handset port. The block diagram in FIG. 20 represents an example of a complete system. The hardware is connected to telephone exchange via one RJ11 connector, and on another RJ11 local telephone instrument is connected. Internet connectivity to the hardware is provided through router using RJ45 connector. The Ethernet PHY is connected to the processor which will give Ethernet connectivity. The local telephone instrument will be connected to the SLIC (Subscriber Line Interface Circuit) and the PSTN/Exchange will be connected to DAA (Data Access Arrangement). The system will run on Linux operating system.

The base station should be connected to home phone lines and an Ethernet port. The base station is connected to telephone exchange via one RJ11 connector and on another RJ11 local telephone instrument is connected. Internet connectivity to the hardware is provided through router using RJ45 connector.

The base station will receive its own IP address over DHCP when it is connected to home network. Its own IP address over DHCP shall be set or changed through the configuration process.

The base station contacts the server for user registration on power up. A Registration Server may be used to create first time users. Using this server, new users may create their accounts and later on modify their accounts. A User Directory database is created by the Registration Server. The software running on the company's server is responsible for maintaining the user directory and their presence information. Presence information means whether a user's base station is online or if the client's software is executing on the user's base station. During the power up, the client software running in the base station shall communicate with registration server. Presence information is always up to date in real time and communicated to the user base stations. The user also goes through a setup process during which it identifies and enters other users whose base stations they will be using for making international phone calls.

A user may perform registration via the client software running on a base station (hardware module) through the Ethernet interface to the server application. The client software running on the base station on top of Embedded Linux operating system can be programmed to pick up online activities during certain hours. The registration is performed through the Ethernet interface. The Ethernet interface shall connect the Internet router to the DSL line. The online activities may include, for example, login, logoff, conveying presence information to a central server, maintaining real time presence information about friends and service providers, conveying that it is ready to accept telephone calls or internet calls from another community user, checking if the modem line is connected or working, and in case of malfunction display a message, checking if internet connection is active, and in case of malfunction display a message.

Modules may perform software updates once a day if new updates are available on the company server. The client software may periodically inform a Presence Server about its active status. The Presence Server maintains a list of active users in a User Presence database. If there is updated client software available, the base station may perform client software update based on a Presence Server request.

The local telephone handset may have the capability to make and receive VOIP phone calls. The second RJ11 connector from the base station may offer the capability to make and receive VOIP phone call. The microcontroller shall detect the phone number and check whether or not it matches the circle on the list. If it matches, it shall perform the calling through the XMPP peer-to-peer connection.

The invention may also involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

Thus, the invention provides a method and apparatus for enabling low-cost communication via a voice network created with, for example, a user's subscribed cellular network, a PSTN network, and the internet Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method, comprising:
receiving, at an origin device, input from a first telephonic device via an origin telephonic landline;
outputting an initiation request based on the input to a destination device, wherein the destination device is configured to output a call request to a second telephonic device via a destination telephonic landline.

2. The method of claim 1, wherein the initiation request is output according to the input received.

3. The method of claim 1, wherein the input includes a telephone number.

4. The method of claim 1, wherein the input includes a first telephone number and a second telephone number.

5. The method of claim 4, wherein the origin telephonic landline serves as an interface for the first telephone number, and the second telephonic device serves as an interface for the second telephone number.

6. The method of claim 4, wherein the origin device includes an origin modem coupled to the origin telephonic landline, and the destination device includes a destination modem coupled to the destination telephonic landline.

7. The method of claim 6, wherein the origin modem receives the second telephone number via Dual Tone Multi-Frequency (DTMF) tones.

8. The method of claim 1, wherein the call request includes data representing the second telephone number.

9. The method of claim 1, wherein the initiation request establishes a peer-to-peer connection between the origin device and the destination device.

10. The method of claim 1, wherein the initiation request is conducted via Voice-over-Internet-Protocol (VoIP).

11. The method of claim 1, wherein at least one of the first telephonic device and the second telephonic device is a mobile device.

12. The method of claim 1, wherein the destination telephonic landline is located in a country outside of that in which the origin telephonic landline is located.

13. The method of claim 1, further comprising:
sending an inquiry to a server; and
receiving a response including information related to the destination device, wherein the destination device is selected based on data in the server.

14. The method of claim 13, wherein the data includes at least one of the group consisting of user directory, information regarding online status, and information regarding software execution status.

15. A method, comprising:
receiving, at a destination device, an initiation request from an origin device based on input, wherein the input is from a first telephonic device via an origin telephonic landline to the origin device; and
outputting a call request to a second telephonic device via a destination telephonic landline.

16. A method, comprising:
receiving, at a server, a request from an origin device, wherein the origin device is configured to receive input from a first telephonic device via an origin telephonic landline; and
outputting information, based on the input, regarding a destination device to the origin device, wherein the destination device is configured to output a call request to a second telephonic device via a destination telephonic landline.

17. A system, comprising:
a control channel configured to receive and initiate telephonic communications from a telephonic device;
an input channel configured to receive analog origin voice data, convert the analog origin voice data into digital origin voice data, format the digital origin voice data into origin packets, and send the origin packets to a destination device; and
an output channel configured to receive destination packets including digital destination voice data, extract the digital destination voice data from the destination packets, convert the digital destination voice data into analog destination voice data, and send the analog destination voice data to the telephonic device.

18. A method, comprising:
receiving, at an origin device, user input; and
outputting an initiation request based on the user input to a destination device, wherein the destination device is configured to output a call request to a telephonic device via a destination telephonic landline.

19. A method, comprising:
receiving, at an origin device, input from a first telephonic device via an origin telephonic landline; and
outputting an initiation request based on the input to a destination device, wherein the destination device is configured to initiate a voice communication connection.

20. A method as in any one of the preceding claims, in which one of the origin device and the destination device is chosen from the group consisting of a computer and a hardware module.

21. The method of claim 20, wherein the hardware module includes:
a modem;
an modem analog controller coupled to the modem, wherein the modem analog controller is configured to receive and output analog voice data;
a processor coupled to the modem, wherein the processor executes client software; and
an Ethernet port coupled to the processor.

22. The method of claim 21, wherein the hardware module further includes:
a phone handset interface coupled to the processor.

23. The method of claim 21, wherein the hardware module further includes:
a SDRAM coupled to the processor.

24. The method of claim 21, wherein the hardware module further includes:
a flash memory coupled to the processor.

25. A device, comprising:
a modem;
an modem analog controller coupled to the modem, wherein the modem analog controller is configured to receive and output analog voice data;
a processor coupled to the modem, wherein the processor executes client software; and
an Ethernet port coupled to the processor.

26. A device of claim 25, further comprising:
a phone handset interface coupled to the processor.

27. A device of claim 25, further comprising:
a SDRAM coupled to the processor.

28. A device of claim 25, further comprising:
a flash memory coupled to the processor.
